(19) United States
(12) Patent Application Publication
(10) Pub. No.: US 2026/0111295 A1
(43) Pub. Date: Apr. 23, 2026

(54) Object Storage Remote Direct Memory Access

(71) Applicant: Dell Products L.P., Round Rock, TX (US)

(72) Inventors: Jason Goldschmidt, Newton, MA (US); Adrian Michaud, Carlisle, MA (US); Emine Ugur Kaynar Terzioglu, Boston, MA (US); John P. Marchese, JR., East Hampton, CT (US); Michael Marrotte, Windermere, FL (US)

(21) Appl. No.: 18/919,152

(22) Filed: Oct. 17, 2024

(51) Int. Cl. G06F 9/54; G06F 15/173

(52) U.S. Cl. CPC G06F 9/547; G06F 15/17331

(57) ABSTRACT

A system can receive a connection message from a remote computer at a remote procedure call (RPC) endpoint. The system can send, to the remote computer, a remote direct memory access identifier via the RPC endpoint. The system can receive an object storage operation message from the remote computer at the RPC endpoint, wherein the object storage operation message identifies an object storage operation and an offset from a starting point of a data storage address of memory. The system can perform the object storage operation on a portion of the memory associated with the remote computer starting at the offset from the starting point of the data storage address of the memory associated with the remote computer, via a remote direct memory access operation. The system can send, to the remote computer, an RPC response that indicates that the object storage operation was successful.

### BACKGROUND

Object storage generally comprises a type of computer storage where data is stored as an object in a namespace.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can expose a remote procedure call endpoint that is accessible by a remote computer to request performing object storage operations with the system. The system can receive a connection message from the remote computer at the remote procedure call endpoint, wherein the connection message identifies a data storage address of memory associated with the remote computer. The system can, based on receiving the connection message, send, to the remote computer, a remote direct memory access identifier via the remote procedure call endpoint. The system can, after sending the remote direct memory access identifier to the remote computer, receive an object storage operation message from the remote computer at the remote procedure call endpoint, wherein the object storage operation message identifies an object storage operation and an offset from a starting point of the data storage address of the memory. The system can perform the object storage operation on a portion of the memory associated with the remote computer starting at the offset from the starting point of the data storage address of the memory associated with the remote computer, via a remote direct memory access operation. The system can, based on determining, from a remote direct memory access event queue of the system, that the object storage operation has completed, send, to the remote computer, a remote procedure call response that indicates that the object storage operation was successful, wherein the remote procedure call response omits data of the object storage operation.

An example method can comprise receiving, by a system comprising at least one processor, a connection message from a remote computer at a remote procedure call endpoint, wherein the connection message identifies a data storage address of memory associated with the remote computer. The method can further comprise sending, by the system to the remote computer, a remote direct memory access identifier via the remote procedure call endpoint. The method can further comprise receiving, by the system, an object storage operation message from the remote computer at the remote procedure call endpoint, wherein the object storage operation message identifies an object storage operation and an offset from a starting point of the data storage address of the memory. The method can further comprise performing, by the system, the object storage operation on a portion of the memory associated with the remote computer starting at the offset from the starting point of the data storage address of the memory associated with the remote computer, via a remote direct memory access operation. The method can further comprise sending, by the system to the remote computer, a remote procedure call response that indicates that the object storage operation was successful, wherein the remote procedure call response omits data of the object storage operation.

An example non-transitory computer-readable medium can comprise instructions that, in response to execution, cause a system comprising a processor to perform operations. These operations can comprise receiving a connection message from a remote computer at a remote procedure call endpoint, wherein the connection message identifies a data storage address of memory associated with the remote computer. These operations can further comprise sending, to the remote computer, a remote direct memory access identifier via the remote procedure call endpoint. These operations can further comprise receiving an object storage operation message from the remote computer at the remote procedure call endpoint, wherein the object storage operation message identifies an object storage operation. These operations can further comprise performing the object storage operation on memory associated with the remote computer, via a remote direct memory access operation. These operations can further comprise sending, to the remote computer, a remote procedure call response that indicates that the object storage operation was successful.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate object storage remote direct memory access (RDMA), in accordance with an embodiment of this disclosure;

FIG. 2 illustrates an example of a protocol stack, and that can facilitate object storage RDMA, in accordance with an embodiment of this disclosure;

FIG. 3 illustrates an example of an object storage RPC, and that can facilitate object storage RDMA, in accordance with an embodiment of this disclosure;

FIG. 4 illustrates an example of an object storage RPC RDMA connection creation request, and that can facilitate object storage RDMA, in accordance with an embodiment of this disclosure;

FIG. 5 illustrates an example of an object storage RPC RDMA connection creation response, and that can facilitate object storage RDMA, in accordance with an embodiment of this disclosure;

FIG. 6 illustrates an example of an object storage RPC GetObject with RDMA data mode request, and that can facilitate object storage RDMA, in accordance with an embodiment of this disclosure;

FIG. 7 illustrates an example of an object storage RPC GetObject with RDMA data mode processing, and that can facilitate object storage RDMA, in accordance with an embodiment of this disclosure;

FIG. 8 illustrates an example of an object storage RPC GetObject with RDMA data mode response, and that can facilitate object storage RDMA, in accordance with an embodiment of this disclosure;

FIG. 9 illustrates an example chart of GET performance comparison, and that can facilitate object storage RDMA, in accordance with an embodiment of this disclosure;

FIG. 10 illustrates another example chart of GET performance comparison, and that can facilitate object storage RDMA, in accordance with an embodiment of this disclosure;

FIG. 11 illustrates an example chart of PUT performance comparison, and that can facilitate object storage RDMA, in accordance with an embodiment of this disclosure;

FIG. 12 illustrates another example chart of PUT performance comparison, and that can facilitate object storage RDMA, in accordance with an embodiment of this disclosure;

FIG. 13 illustrates an example of an object storage RPC with endpoint sessions, and that can facilitate object storage RDMA, in accordance with an embodiment of this disclosure;

FIG. 14 illustrates an example process flow that can facilitate object storage RDMA, in accordance with an embodiment of this disclosure;

FIG. 15 illustrates another example process flow that can facilitate object storage RDMA, in accordance with an embodiment of this disclosure;

FIG. 16 illustrates another example process flow that can facilitate object storage RDMA, in accordance with an embodiment of this disclosure; and

FIG. 17 illustrates an example block diagram of a computer operable to execute an embodiment of this disclosure.

### DETAILED DESCRIPTION

### Overview

An object storage protocol can generally comprise a protocol whereby computer data is stored as objects with a unique identifier (as compared to being stored as files in a hierarchy of directories). A remote procedure call can generally comprise one computer invoking execution of a procedure on another computer. RDMA can generally comprise a direct memory access of the memory of one computer by another computer (such as without involving the operating system of the computer which has its memory being accessed).

There can be a trend toward generative artificial intelligence (Gen AI) applications on cloud computing platforms. It can be that object storage (where computer data is stored as objects in buckets in a namespace) is disfavored in AI applications due to relatively-high latency of object storage operations. Similarly, object storage performance can hinder object storage operation implementation for generative AI applications on premises (sometimes referred to as on prem).

These problems with object storage latency can be addressed via the present techniques. This can be a benefit because objects can offer better control mechanisms than files in file storage. Additionally, object storage can offer improved scale out compared to file storage.

The present techniques can facilitate object storage via remote procedure calls (RPCs) utilizing remote direct memory access (RDMA). This can be referred to as object storage RDMA. The present techniques can facilitate a high-performance, low-latency storage system on prem for an application developed for object storage. Such an application developed for object storage can run unmodified, and with significant performance improvements where the present techniques are implemented. RDMA can be utilized to facilitate high-throughput direct data placement with low latency.

It can be that object storage data transfer latency has prevented its adoption for Gen AI workloads. It can be that object storage over Hyper Text Transfer Protocol/1.1 (HTTP/1.1) can scale for high throughput through parallel operation. However, it can be that it does not perform at sub-millisecond latency for smaller (<1 megabyte (MB)) objects.

Object storage RPC can comprise a protocol for object storage operations. Object storage RPC can define an RPC program that includes operations that are compatible with an object storage actions application programming interface (API) and protocol semantics. Utilizing RPC over Transmission Control Protocol (TCP) can enable a stateful and scalable connection model that supports low-latency RPC operations between client and server. The use of RPC can greatly reduce the response time when compared to traditional object storage over HTTP/1.1. RPC can provide a rich set of authentication and authorization mechanisms, which can be a stateful aspect of the protocol. As a result, object storage RPC can authenticate with fewer operations, compared to object storage HTTP/1.1, which can require authentication/authorization on each API action.

An object storage RPC can define an OBJECT_STORAGE_PROC_MESSAGE procedure that includes an array of operations as part of its request payload. Each operation can support a protocol operation and provide support for a sub-set of object storage actions (e.g., ListBuckets, GetObject, PutObject, etc.). The RPC program can be described using an interactive data language (IDL).

The object storage RPC client can connect to the object storage RPC server using the RPC framework, operating over a reliable transport (such as TCP). The client can perform object storage actions against the object storage RPC server and receive responses indicating the result of the action. This can include:
Bucket operations: ListBuckets, CreateBucket, DeleteBucket
Object management operations: ListObjects, HeadObject, DeleteObject
Object data operations: GetObject, PutObject, CreateMultipartUpload, UploadPart, CompleteMultiPartUpload

Performing object storage actions as object storage RPC operations can result in ⅓-¼ of the latency compared to traditional object storage HTTP/1.1, due to the RPC connection/authorization model and efficient procedure packing in payload marshaling and un-marshaling.

Object storage RPC can operate independently of the storage backend utilized. It can operate with direct attached storage, as part of a clustered scaleout filesystem, as a front-end to a key-value-store, and/or fabric attached storage/memory.

The present techniques can facilitate a new protocol providing compatibility with an object storage action API and protocol semantics as an RPC program. The present techniques can be implemented to deliver far lower latency compared to traditional object storage. The present techniques can be implemented to allow for extensibility of new actions beyond protocol definition.

The following example data structures can be used in implementing the present techniques.

The following is an example objectstorage_part resource type for multipart uploads.

```
struct objectstorage_part {
  md5sum p_etag;
  uint16_t p_part_number;
  uint64_t p_size;
  timestamp p_last_modified;
};
```

GetObject can be implemented as follows. OBJECTSTORAGEOP_GET_OBJECT can retrieve an object from an object storage RPC server. Status codes can include OBJECTSTORAGE_OK or OBJECTSTORAGEERR_NOENT (object does not exist.) Byte ranges can be specified using an offset and count. It can be that multiple byte ranges are not supported in a single request. An offset of zero can mean starting the byte count to return from the beginning of the file. If the offset is greater than or equal to the size of the object, the status OBJECTSTORAGE_OK can be returned with a content length set to zero.

The operation can be limited to a MAX_UINT chunk size. This can be the maximum chunk size that can be written for an object in a single OBJECTSTORAGEOP_PUT_OBJECT operation. To retrieve an object that is larger, multiple parallel operations can be used to get multiple chunks of the object (by specifying an offset and count.) It can be that a client can spread these operations across multiple endpoint session slots in order to maximize parallelism. Performance characteristics of the client, server, and network can determine a more optimized chunk size for objects. Object storage common runtime libraries can use 8 megabyte (MB) chunks for put and get operations. It can be that the same chunk size is used for both put and get operations.

When inline data mode is requested by the client (goa_is_direct=FALSE), the object data can be sent in the response message as an opaque byte stream. The size of the returned object (or range) can be encoded in the IDL of the opaque data response.

When direct data placement mode is requested by the client (goa_data_mode==OBJECTSTORAGE_DATA_RDMA/TCP), the object data can be written to the client utilizing an alternate data transfer channel. The object data can be written to the remote buffer at the specified offset. After the direct data placement (DDP) DDP write is complete, the server can send the object storage RPC response indicating the length of the object written to the remote memory buffer.

For OBJECTSTORAGE_DATA_RDMA data mode, the client can specify the RDMA connection ID as an argument. This connection ID can be used to match against an existing RDMA connection between the object storage RPC server and client. If the connection described by the argument does not exist, OBJECTSTORAGEERR_RDMA_INVAL can be returned.

```
struct GET_OBJECTdirectargs {
    uint64_t goa_buffer_start;
    uint64_t goa_buffer_offset;
};
struct GET_OBJECTrdmaargs {
    uint64_t goa_buffer_offset;
    uint64_t goa_rdma_connection_id;
};
union GET_OBJECTdataargs switch (objectstorage_data_modes goa_data_mode) {
    case OBJECTSTORAGE_DATA_TCP:
      GET_OBJECTtcpargs goa_tcp;
    case OBJECTSTORAGE_DATA_RDMA:
      GET_OBJECTrdmaargs goa_rdma;
    case OBJECTSTORAGE_DATA_INLINE:
      void;
};
struct GET_OBJECTargs {
```

| | |
|---|---|
| utf8string | goa_bucket_name; |
| utf8string | goa_key; |
| uint64_t | goa_offset; |
| uint32_t | goa_count; |

```
    GET_OBJECTdataargs goa_data;
};
opnum OBJECTSTORAGEOP_GET_OBJECT = 7;
union GET_OBJECTdatares switch (objectstorage_data_modes gor_data_mode) {
    case OBJECTSTORAGE_DATA_TCP:
    case OBJECTSTORAGE_DATA_RDMA:
      uint64_t gor_content_len;
    case OBJECTSTORAGE_DATA_INLINE:
      opaque gor_body<>;
};
struct GET_OBJECTresok {
```

| | |
|---|---|
| utf8string | gor_content_type; |
| timestamp | gor_last_modified; |
| md5sum | gor_etag; |

GET_OBJECTdatcan bes gor_data;
};

PutObject can be implemented as follows. An OBJECTSTORAGEOP_PUT_OBJECT operation can add an object to a bucket using a specified key. A successful response to this operation can indicate that the entire object was added to the bucket. Subsequent put operations to the object, as identified by the bucket and key, can overwrite the existing object and metadata.

The maximum size that can be written in a single operation can be MAX_UINT bytes (˜4 gigabytes (GB)). For an object larger than this limit, a multiple part upload can be used. In some examples, performance characteristics of the client, server, and network can determine a more optimized chunk size for objects. Object storage common runtime (CRT) libraries can use 8 MB chunks for put and get operations. It can be that the same chunk size is used for both put and get operations.

If inline data transfer mode is specified in the request (OBJECTSTORAGE_DATA_INLINE), the client can send the data as an opaque byte stream in the request.

Direct data transfer modes (OBJECTSTORAGE_DATA_RDMA/TCP) can provide information to the object storage RPC server about where to read the remote buffer. Failure to read the remote memory buffer can result in OBJECTSTORAGEERR_IO.

For OBJECTSTORAGE_DATA_RDMA data mode, the client can specify the RDMA connection ID as an argument. This connection ID can be used to match against an existing RDMA connection between the object storage RPC server and client. If the connection described by the argument does not exist, OBJECTSTORAGEERR_RDMA_INVAL can be returned.

```
struct PUT_OBJECTdirectargs {
    uint64_t poa_buffer_start;
    uint64_t poa_buffer_len;
    uint64_t poa_buffer_offset;
    };
struct PUT_OBJECTrdmaargs {
    uint64_t poa_buffer_len;
    uint64_t poa_buffer_offset;
    uint64_t poa_rdma_connection_id;
};
union PUT_OBJECTdata switch (objectstorage_data_modes poa_data_mode) {
    case OBJECTSTORAGE_DATA_TCP:
        PUT_OBJECTtcpargs poa_tcp;
    case OBJECTSTORAGE_DATA_RDMA:
        PUT_OBJECTrdmaargs poa_rdma;
    case OBJECTSTORAGE_DATA_INLINE:
        opaque poa_body<>;
};
struct PUT_OBJECTargs {
```

| | |
|---|---|
| utf8string | poa_bucket_name; |
| utf8string | poa_key; |
| PUT_OBJECTdata | poa_data; |

```
};
opnum OBJECTSTORAGEOP_PUT_OBJECT = 12;
struct PUT_OBJECTresok {
  uint64_t por_etag;
};
union PUT_OBJECTres switch (stat por_status) {
  case OBJECTSTORAGE_OK:
      PUT_OBJECTresok por_resok;
  default:
      void;
};
```

CreateMultipartUpload can be implemented as follows. The OBJECTSTORAGEOP_CREATE_MULTIPART_UPLOAD operation can initiate a multiple part upload and return an upload ID to use when uploading parts of a larger object.

| struct CREATE_MULTIPART_UPLOADargs { | |
|---|---|
| utf8string | cmua_bucket_name; |
| utf8string | cmua_key; |

```
};
opnum OBJECTSTORAGEOP_CREATE_MULTIPART_UPLOAD = 15;
struct CREATE_MULTIPART_UPLOADresok {
  utf8string cmur_bucket_name;
  utf8string cmur_key;
  utf8string cmur_upload_id;
};
union CREATE_MULTIPART_UPLOADres switch (stat cmur_status) {
  case OBJECTSTORAGE_OK:
      CREATE_MULTIPART_UPLOADresok cmur_resok;
  default:
      void;
};
```

UploadPart can be implemented as follows. In some examples, UploadPart and PutObject can be combined into a single operation with specific handling by the server to differentiate based on the requests. In other examples, these can be defined as separate operations.

The OBJECTSTORAGEOP_UPLOAD_PART can upload a part in a multipart upload. It can be a special kind of PutObject operation that writes a portion of an object to a bucket and assigns a part number. In some examples, part numbers can be any number from 1 to 10,000 inclusive. A part number can uniquely identify the portion of the object being uploaded and define its position within the object being created. If an upload is performed using a part number that has previously been uploaded, the data can be overwritten.

If inline data transfer mode is specified in the request (OBJECTSTORAGE_DATA_INLINE), the client can send the data as an opaque byte stream in the request.

Direct data transfer modes (OBJECTSTORAGE_DATA_RDMA/TCP) can provide information to the object storage RPC server about where to read the remote buffer. Failure to read the remote memory buffer can result in OBJECTSTORAGEERR_IO.

For OBJECTSTORAGE_DATA_RDMA data mode, the client can specify the RDMA connection ID as an argument. This connection ID can be used to match against an existing RDMA connection between the object storage RPC server and client. If the connection described by the argument does not exist, OBJECTSTORAGEERR_RDMA_INVAL can be returned.

```
struct UPLOAD_PARTdirectargs {
    uint64_t upa_buffer_start;
    uint64_t upa_buffer_len;
    uint64_t upa_buffer_offset;
};
struct UPLOAD_PARTrdmaargs {
    uint64_t upa_buffer_len;
    uint64_t upa_buffer_offset;
    uint64_t upa_rdma_connection_id;
};
union UPLOAD_PARTdata switch (objectstorage_data_modes upa_data_mode) {
    case OBJECTSTORAGE_DATA_TCP:
        UPLOAD_PARTtcpargs upa_tcp;
    case OBJECTSTORAGE_DATA_RDMA:
        UPLOAD_PARTrdmaargs upa_rdma;
    case OBJECTSTORAGE_DATA_INLINE:
        opaque upa_body<>;
};
struct UPLOAD_PARTargs {
```

| | |
|---|---|
| utf8string | upa_bucket_name; |
| utf8string | upa_key; |
| utf8string | upa_upload_id; |
| uint16_t | upa_part_number; |

```
    UPLOAD_PARTdata upa_data;
};
opnum OBJECTSTORAGEOP_UPLOAD_PART = 16;
struct UPLOAD_PARTresok {
  uint64_t upr_etag;
};
union UPLOAD_PARTres switch (stat upr_status) {
  case OBJECTSTORAGE_OK:
      UPLOAD_PARTresok upr_resok;
  default:
      void;
};
```

RDMAConnect can be implemented as follows. An OBJECTSTORAGEOP_RDMA_CONNECT can be issued by the client to inform the object storage RPC server to create an RDMA connection back to the client, for direct data transfers. If setting up the connection fails, OBJECTSTORAGEERR_RDMA_CONNECT can be returned.

```
struct RDMA_CONNECTargs {
    uint64_t rca_rkey;
    uint64_t rca_remote_addr;
    uint64_t rca_qp_num;
    uint64_t rca_mtu;
    uint64_t rca_lid;
    uint8_t rca_gid[16];
};
opnum OBJECTSTORAGEOP_RDMA_CONNECT = 19;
struct RDMA_CONNECTresok {
    uint64_t rcr_rkey;
    uint64_t rcr_remote_addr;
    uint64_t rcr_qp_num;
    uint64_t rcr_mtu;
    uint64_t rcr_lid;
    uint64_t rcr_rdma_connection_id;
    uint8_t rcr_gid[16];
};
union RDMA_CONNECTres switch (stat rcr_status) {
  case OBJECTSTORAGE_OK:
      RDMA_CONNECTresok rcr_resok;
  default:
      void;
};
```

RDMADisconnect can be implemented as follows. An OBJECTSTORAGEOP_RDMA_DISCONNECT can be issued by the client to inform the object storage RPC server to close its RDMA connection back to the client. The server can free any resources associated with this RDMA connection. Any subsequent uses of the RDMA connection id associated with this connection can fail with OBJECTSTORAGEERR_RDMA_INVAL. It can be that any in progress operations must be completed prior to closing the connection and freeing any associated resources.

```
struct RDMA_DISCONNECTargs {
    uint64_t rda_rdma_connection_id;
    uint64_t rda_rkey;
    uint64_t rda_qp_num;
    uint64_t rda_lid;
};
opnum OBJECTSTORAGEOP_RDMA_CONNECT = 20;
struct RDMA_DISCONNECTresok {
    uint64_t rdr_rdma;
};
union RDMA_DISCONNECTres switch (stat rdr_status) {
  case OBJECTSTORAGE_OK:
      RDMA_DISCONNECTresok rdr_resok;
  default:
      void;
};
```

### Example Architectures, etc.

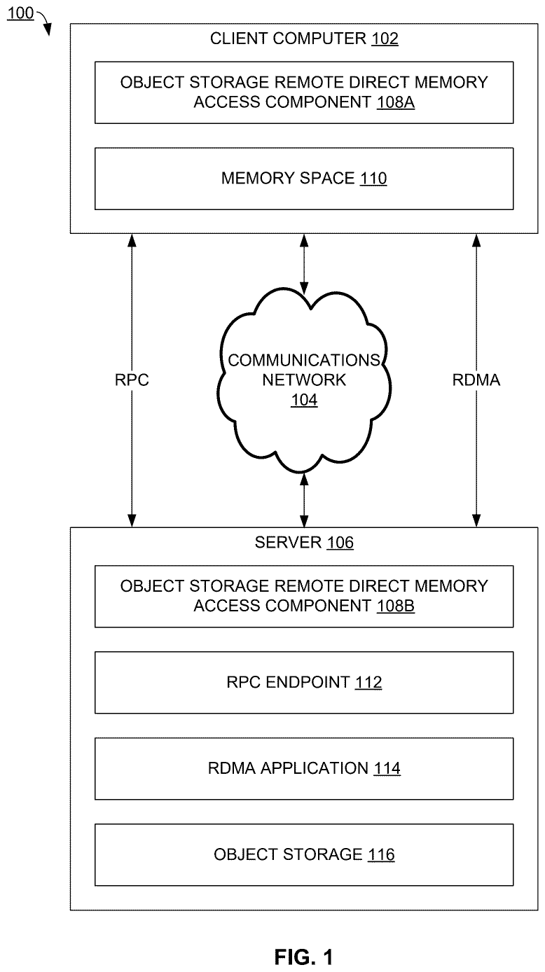

FIG. 1 illustrates an example system architecture 100 that can facilitate object storage RDMA, in accordance with an embodiment of this disclosure.

System architecture 100 comprises client computer 102, communications network 104, and server 106. In turn, client computer 102 comprises object storage RDMA component 108A, and memory space 110. And server 106 comprises object storage RDMA component 108B, RPC endpoint 112, RDMA application 114, and object storage 116.

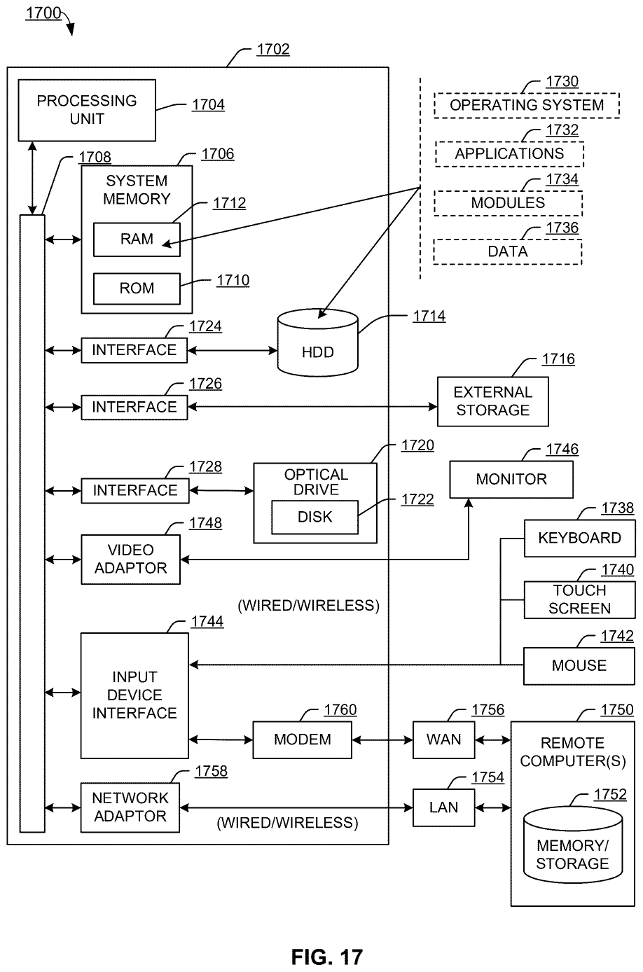

Each of client computer 102 and/or server 106 can be implemented with part(s) of computing environment 1700 of FIG. 17. Communications network 104 can comprise a computer communications network, such as the Internet, or an isolated private computer communications network.

Client computer 102 can communicate with server 106 via communications network 104, to perform object storage commands on object storage 116 via RPC calls made to RPC endpoint 112. This can be effectuated by RDMA transfers, where object storage RDMA component 108A can identify a location in memory space 110 to use for transfers (e.g., to write data to for a GET or to read data from for a PUT).

Object storage RDMA component 108B can effectuate RDMA transfers for server 106, using RDMA application 114 to perform RDMA transfers as part of RPC messages.

It can be that there are two separate communications channels between client computer 102 and server 106—separate RPC and RDMA channels, where the RDMA channel can be considered to be a side-channel of the RPC channel.

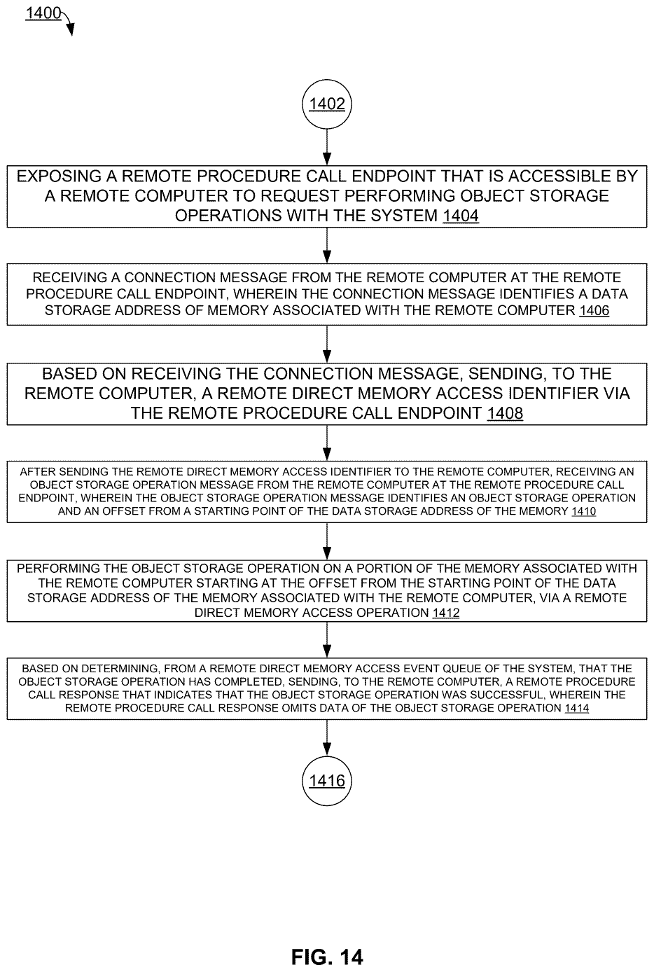

In some examples, object storage RDMA component 118 can implement part(s) of the process flows of FIGS. 14-16 to facilitate object storage RDMA.

It can be appreciated that system architecture 100 is one example system architecture for object storage RDMA, and that there can be other system architectures that facilitate object storage RDMA.

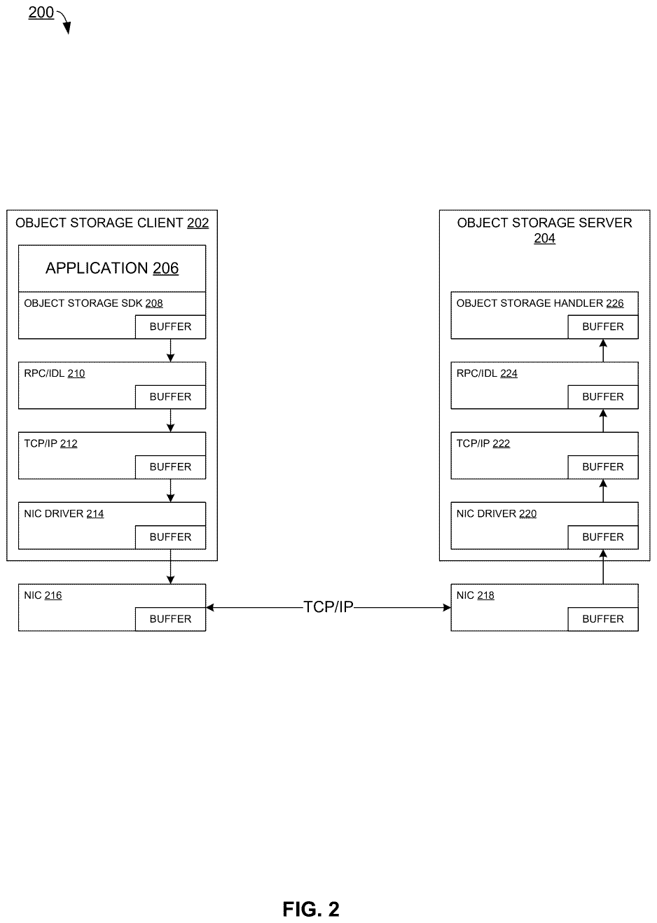

FIG. 2 illustrates an example 200 of a protocol stack, and that can facilitate object storage RDMA, in accordance with an embodiment of this disclosure. In some examples, part(s) of example 200 can be implemented by part(s) of system architecture 100 of FIG. 1 to facilitate object storage RDMA.

Example 200 comprises object storage client 202, object storage server 204, application 206, object storage software development kit (SDK) 208, RPC/IDL 210, TCP/Internet Protocol (IP) 212, network interface card (NIC) driver 214, NIC 216, NIC 218, NIC driver 220, TCP/IP 222, RPC/IDL 224, and object storage handler 226.

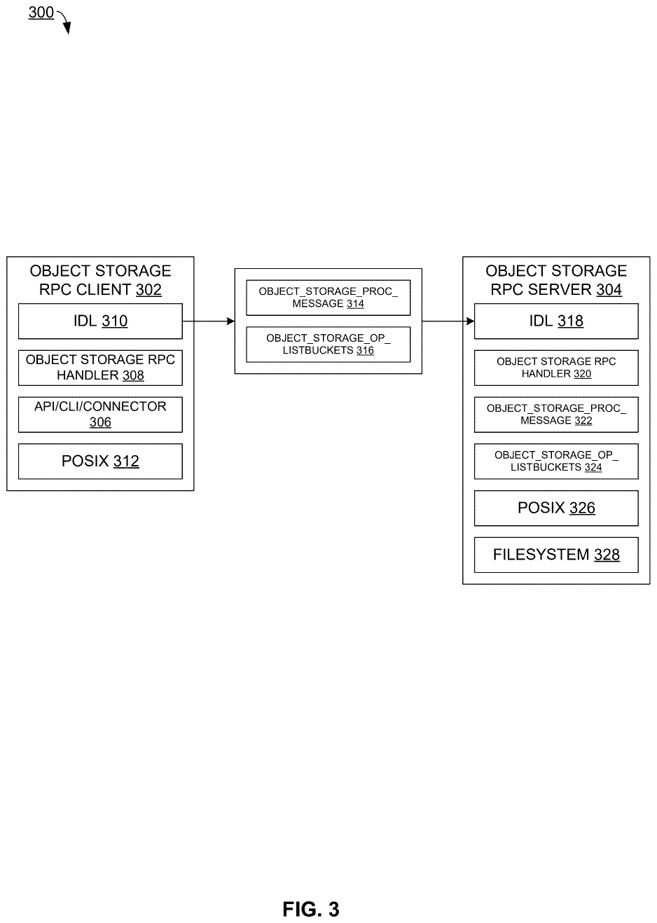

FIG. 3 illustrates an example 300 of an object storage RPC, and that can facilitate object storage RDMA, in accordance with an embodiment of this disclosure. In some examples, part(s) of example 300 can be implemented by part(s) of system architecture 100 of FIG. 1 to facilitate object storage RDMA.

Example 300 comprises object storage RPC client 302, object storage RPC server 304, API/command line interface (CLI)/connector 306, object storage RPC handler 308, IDL 310, Portable Operating System Interface (POSIX) 312, OBJECT_STORAGE_PROC_MESSAGE 314, OBJECT_STORAGE_OP_LISTBUCKETS 316, IDL 318, object storage RPC handler 320, OBJECT_STORAGE_PROC_MESSAGE 322, OBJECT_STORAGE_OP_LISTBUCKETS 324, POSIX 326, and filesystem 328.

The present techniques can facilitate use of side-channel remote direct memory access (RDMA) to accelerate object storage data transfers. An object storage protocol can send data in-line within the body of an HTTP/1.1 message request or response. The data can be received by an endpoint or client and copied into central processing unit (CPU) memory buffers prior to committing to persistent or temporary storage. The number of data copies and CPU utilized can result in high latency during data transfer. This latency can be too high for certain workloads, such as a Gen AI checkpoint.

Object storage RPC can be defined to operate in two data transfer modes: in-line and direct. With the in-line transfer mode, GetObject, PutObject and UploadPart can include data in-line as part of the RPC message payload. With direct data transfer mode, RDMA can be utilized to perform the data transfer directly from the server memory to a destination buffer on the client—that is, without data copy and with greatly reduced CPU utilization. For example, the destination buffer can be CPU memory, graphics processing unit (GPU) memory, or addressable virtual memory on some other device.

Object storage RPC can use a stateful connection model where the object storage RPC client sends an OBJECT_STORAGE_OP_RDMA_CONNECT operation to the object storage RPC server. The message can include information about the remote virtual address, remote keys, and other RDMA descriptors to assist the server in performing RDMA read/write operations against the client. The object storage RPC server can respond with an RDMA connection identifier, for the object storage RPC client to use in direct data transfer operations.

In the case of a GetObject, the object storage RPC client can specify the bucket and key representing the object, offset and length information for the operation, an RDMA connection ID to use, and an offset into the client buffer. The object storage RPC server can process the GetObject RPC message and validate the request. An RDMA side-channel can be utilized to directly write the data into the client memory at the specified offset. The server can monitor the local RDMA event queue to determine when the RDMA write has been completed. The server can then send an object storage RPC response that includes the number of bytes written to the client memory—that is, no data is sent in-line within the response.

In the case of a PutObject, the object storage RPC client can load the data into the registered memory region and issue a PutObject object storage RPC request. This request can contain the bucket and key representing the object (either a new object, or one to be overwritten), the RDMA connection ID, and an offset and length into the local memory region—that is, no data is sent in-line as part of the PutObject request. The object storage RPC server can process the PutObject RPC message and validate the request. An RDMA side-channel can be utilized to directly read the data from the client memory at the specified offset, into the server's memory region. The server can monitor the local RDMA event queue to determine when the RDMA read has been completed. The server can then send an object storage RPC response to the PutObject indicating the data transfer was successful.

The present techniques can be implemented to facilitate a use of RDMA to significantly improve data throughput, reduce latency, and reduce server and client-side CPU utilization for object storage operations. A stateful RDMA connection model can be built into the protocol definition to allow for repeated direct object storage data transfers, without the need to perform RDMA queue pair connections for each operation.

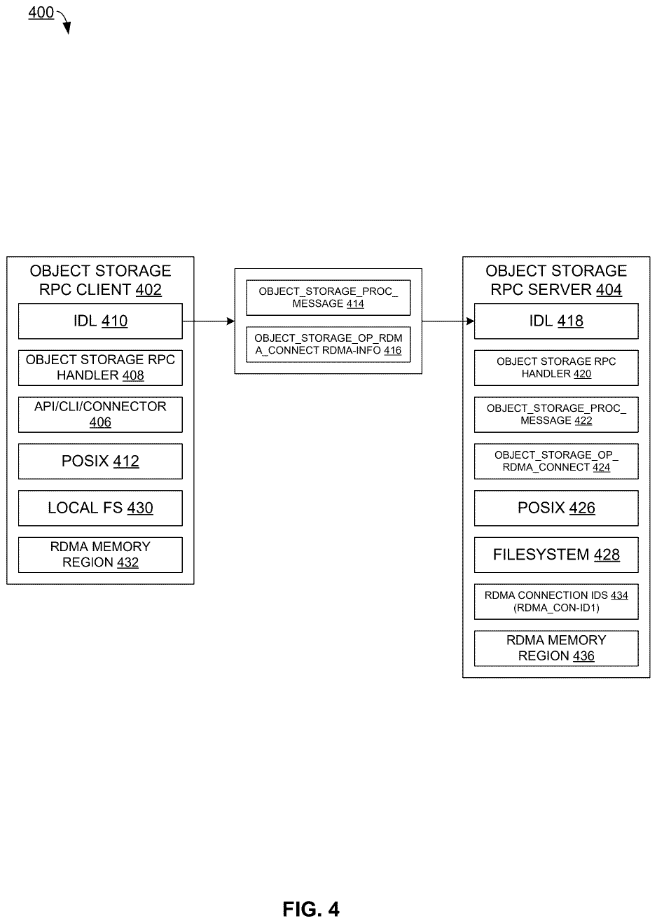

FIG. 4 illustrates an example 400 of an object storage RPC RDMA connection creation request, and that can facilitate object storage RDMA, in accordance with an embodiment of this disclosure. In some examples, part(s) of example 400 can be implemented by part(s) of system architecture 100 of FIG. 1 to facilitate object storage RDMA.

Example 400 comprises object storage RPC client 402, object storage RPC server 404, API/command line interface (CLI)/connector 406, object storage RPC handler 408, IDL 410, Portable Operating System Interface (POSIX) 412, OBJECT_STORAGE_PROC_MESSAGE 414, IDL 418, object storage RPC handler 420, OBJECT_STORAGE_PROC_MESSAGE 422, POSIX 426, and filesystem 428. These parts of example 400 can be similar to object storage RPC client 302, object storage RPC server 304, API/command line interface (CLI)/connector 306, object storage RPC handler 308, IDL 310, Portable Operating System Interface (POSIX) 312, OBJECT_STORAGE_PROC_MESSAGE 314, IDL 318, object storage RPC handler 320, OBJECT_STORAGE_PROC_MESSAGE 322, POSIX 326, and filesystem 328, respectively.

Example 400 also comprises OBJECT_STORAGE_OP_RDMA_CONNECT RDMA-info 416, OBJECT_STORAGE_OP_RDMA_CONNECT 424, local FS 430, RDMA memory region 432, RDMA connection IDs 434, and RDMA memory region 436.

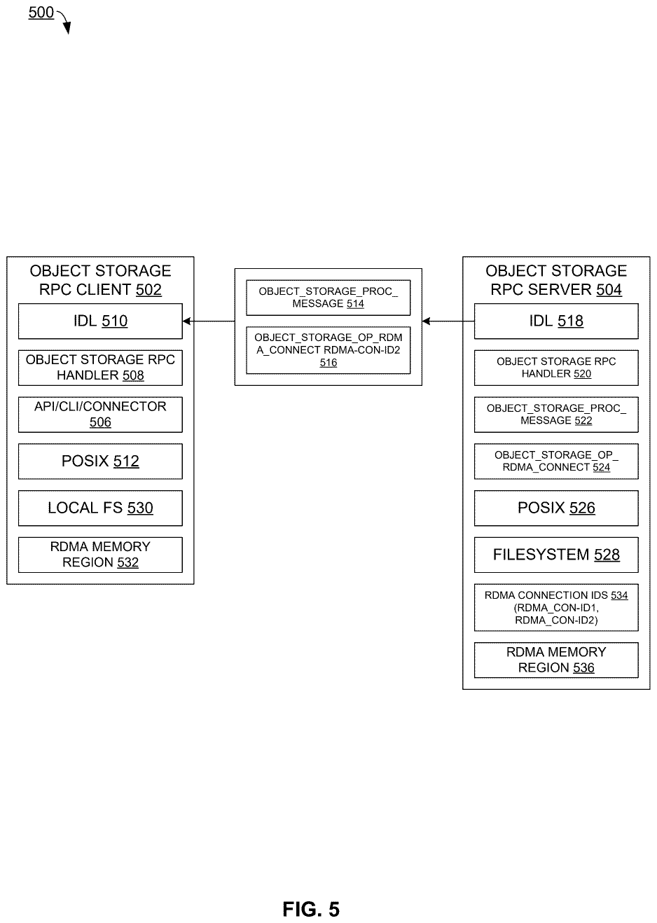

FIG. 5 illustrates an example 500 of an object storage RPC RDMA connection creation response, and that can facilitate object storage RDMA, in accordance with an embodiment of this disclosure. In some examples, part(s) of example 500 can be implemented by part(s) of system architecture 100 of FIG. 1 to facilitate object storage RDMA.

Example 500 comprises object storage RPC client 502, object storage RPC server 504, API/command line interface (CLI)/connector 506, object storage RPC handler 508, IDL 510, Portable Operating System Interface (POSIX) 512, OBJECT_STORAGE_PROC_MESSAGE 514, IDL 518, object storage RPC handler 520, OBJECT_STORAGE_PROC_MESSAGE 522, OBJECT_STORAGE_OP_RDMA_CONNECT 524, POSIX 526, filesystem 528, local FS 530, RDMA memory region 532, RDMA connection IDs 534, and RDMA memory region 536. These parts of example 500 can be similar to object storage RPC client 402, object storage RPC server 404, API/command line interface (CLI)/connector 406, object storage RPC handler 408, IDL 410, Portable Operating System Interface (POSIX) 412, OBJECT_STORAGE_PROC_MESSAGE 414, IDL 418, object storage RPC handler 420, OBJECT_STORAGE_PROC_MESSAGE 422, OBJECT_STORAGE_OP_RDMA_CONNECT 424, POSIX 426, filesystem 428, local FS 430, RDMA memory region 432, RDMA connection IDs 434, and RDMA memory region 436, respectively

Example 500 also comprises OBJECT_STORAGE_OP_RDMA_CONNECT RDMA-con-id2 516.

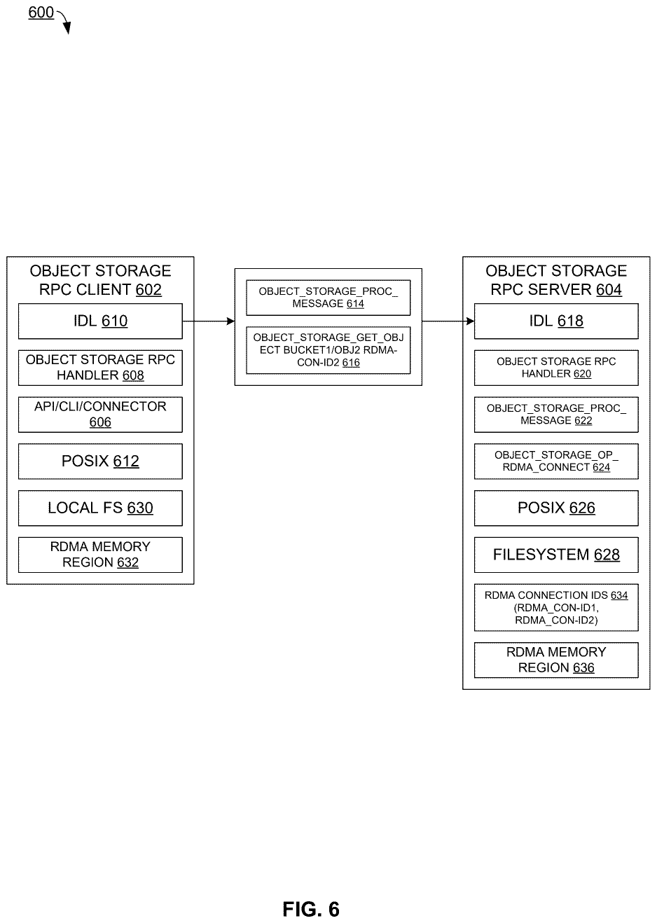

FIG. 6 illustrates an example 600 of an object storage RPC GetObject with RDMA data mode request, and that can facilitate object storage RDMA, in accordance with an embodiment of this disclosure. In some examples, part(s) of example 600 can be implemented by part(s) of system architecture 100 of FIG. 1 to facilitate object storage RDMA.

Example 600 comprises object storage RPC client 602, object storage RPC server 604, API/command line interface (CLI)/connector 606, object storage RPC handler 608, IDL 610, Portable Operating System Interface (POSIX) 612, OBJECT_STORAGE_PROC_MESSAGE 614, IDL 618, object storage RPC handler 620, OBJECT_STORAGE_PROC_MESSAGE 622, OBJECT_STORAGE_OP_RDMA_CONNECT 624, POSIX 626, filesystem 628, local FS 630, RDMA memory region 632, RDMA connection IDs 634, and RDMA memory region 636. These parts of example 600 can be similar to object storage RPC client 402, object storage RPC server 404, API/command line interface (CLI)/connector 406, object storage RPC handler 408, IDL 410, Portable Operating System Interface (POSIX) 412, OBJECT_STORAGE_PROC_MESSAGE 414, IDL 418, object storage RPC handler 420, OBJECT_STORAGE_PROC_MESSAGE 422, OBJECT_STORAGE_OP_RDMA_CONNECT 424, POSIX 426, filesystem 428, local FS 430, RDMA memory region 432, RDMA connection IDs 434, and RDMA memory region 436, respectively

Example 600 also comprises OBJECT_STORAGE_GET_OBJECT bucket1/Obj2 RDMA-con-id2 616.

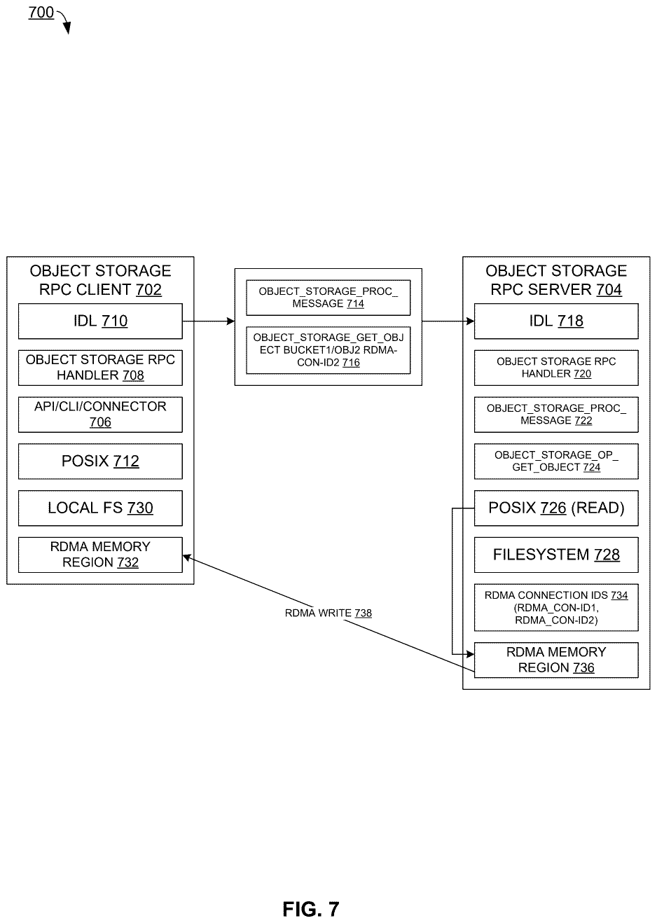

FIG. 7 illustrates an example 700 of an object storage RPC GetObject with RDMA data mode processing, and that can facilitate object storage RDMA, in accordance with an embodiment of this disclosure. In some examples, part(s) of example 700 can be implemented by part(s) of system architecture 100 of FIG. 1 to facilitate object storage RDMA.

Example 700 comprises object storage RPC client 702, object storage RPC server 704, API/command line interface (CLI)/connector 706, object storage RPC handler 708, IDL 710, Portable Operating System Interface (POSIX) 712, OBJECT_STORAGE_PROC_MESSAGE 714, OBJECT_STORAGE_GET_OBJECT bucket1/Obj2 RDMA-con-id2 716, IDL 718, object storage RPC handler 720, OBJECT_STORAGE_PROC_MESSAGE 722, POSIX 726, filesystem 728, local FS 730, RDMA memory region 732, RDMA connection IDs 734, and RDMA memory region 736. These parts of example 700 can be similar to object storage RPC client 602, object storage RPC server 604, API/command line interface (CLI)/connector 606, object storage RPC handler 608, IDL 610, Portable Operating System Interface (POSIX) 612, OBJECT_STORAGE_PROC_MESSAGE 614, OBJECT_STORAGE_GET_OBJECT bucket1/Obj2 RDMA-con-id2 616, IDL 618, object storage RPC handler 620, OBJECT_STORAGE_PROC_MESSAGE 622, POSIX 626, filesystem 628, local FS 630, RDMA memory region 632, RDMA connection IDs 634, and RDMA memory region 636, respectively

Example 700 also comprises OBJECT_STORAGE_OP_GET_OBJECT 724, RDMA write 738.

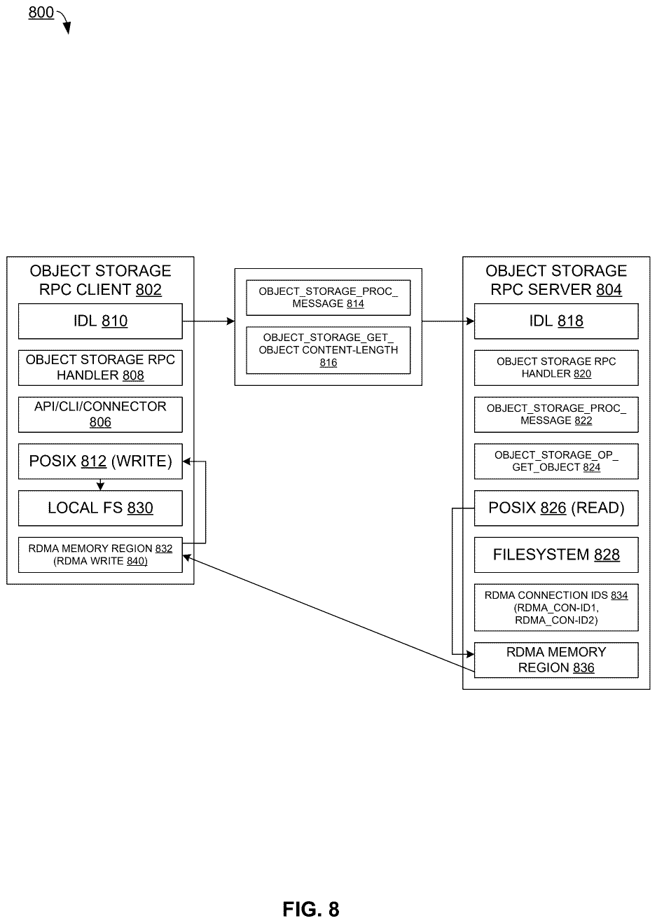

FIG. 8 illustrates an example 800 of an object storage RPC GetObject with RDMA data mode response, and that can facilitate object storage RDMA, in accordance with an embodiment of this disclosure. In some examples, part(s) of example 800 can be implemented by part(s) of system architecture 100 of FIG. 1 to facilitate object storage RDMA.

Example 800 comprises object storage RPC client 802, object storage RPC server 804, API/command line interface (CLI)/connector 806, object storage RPC handler 808, IDL 810, Portable Operating System Interface (POSIX) 812, OBJECT_STORAGE_PROC_MESSAGE 814, IDL 818, object storage RPC handler 820, OBJECT_STORAGE_PROC_MESSAGE 822, OBJECT_STORAGE_OP_GET_OBJECT 824, POSIX 826, filesystem 828, local FS 830, RDMA memory region 832, RDMA connection IDs 834, and RDMA memory region 836. These parts of example 800 can be similar to object storage RPC client 702, object storage RPC server 704, API/command line interface (CLI)/connector 706, object storage RPC handler 708, IDL 710, Portable Operating System Interface (POSIX) 712, OBJECT_STORAGE_PROC_MESSAGE 714, IDL 718, object storage RPC handler 720, OBJECT_STORAGE_PROC_MESSAGE 722, OBJECT_STORAGE_OP_GET_OBJECT 724, POSIX 726, filesystem 728, local FS 730, RDMA memory region 732, RDMA connection IDs 734, and RDMA memory region 736, respectively

Example 800 also comprises OBJECT_STORAGE_GET_OBJECT Content-length 816, RDMA write 840.

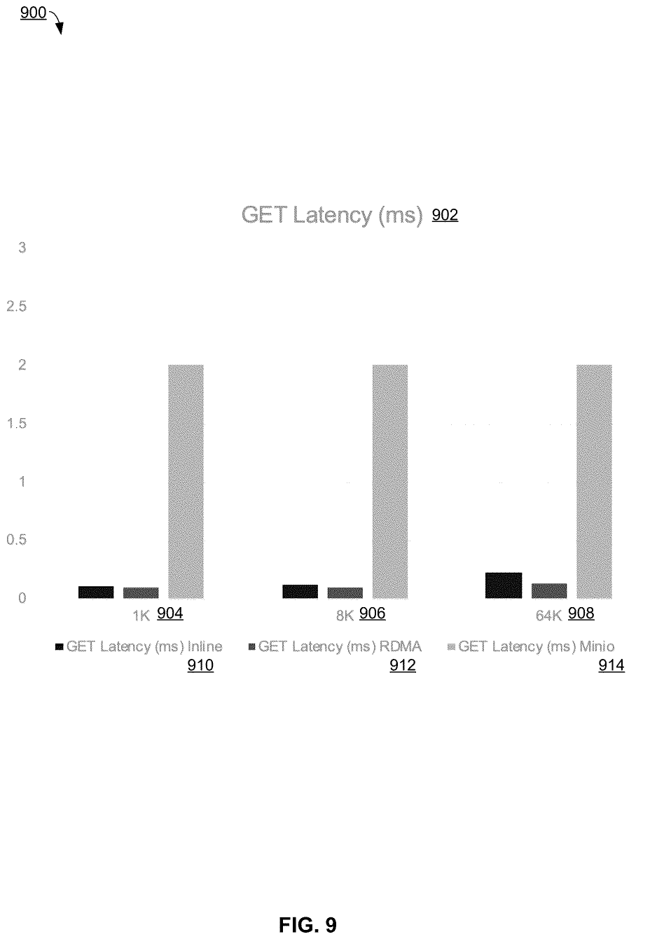

FIG. 9 illustrates an example chart 900 of GET performance comparison, and that can facilitate object storage RDMA, in accordance with an embodiment of this disclosure. In some examples, part(s) of chart 900 can be implemented by part(s) of system architecture 100 of FIG. 1 to facilitate object storage RDMA.

Chart 900 comprises latency (milliseconds (ms)) 902, 1 kilobyte (KB) 904, 8 KB 906, 64 KB 908, GET latency (ms) inline 910, GET latency (ms) RDMA 912, and GET latency (ms) Minio 914.

Chart 900 illustrates latency associated with GET data transfers of different sizes (1 KB, 8 KB, 64 KB) according to different approaches (inline, RDMA, minio). It can be seen that GET latency (ms) RDMA 912 (according to the present techniques) offers the lowest latency at each data size.

In the example of charts 900 and 1000, object storage RPC uses 8 MB chunks (>8 MB is a ranged GetObject). Minio can utilize a single GET operation. RDMA can offer a lower latency for all sizes. RDMA can achieve a 30-50% higher throughput for >=1 MB objects. RDMA can achieve a 10-72% lower latency for <=64 KB objects.

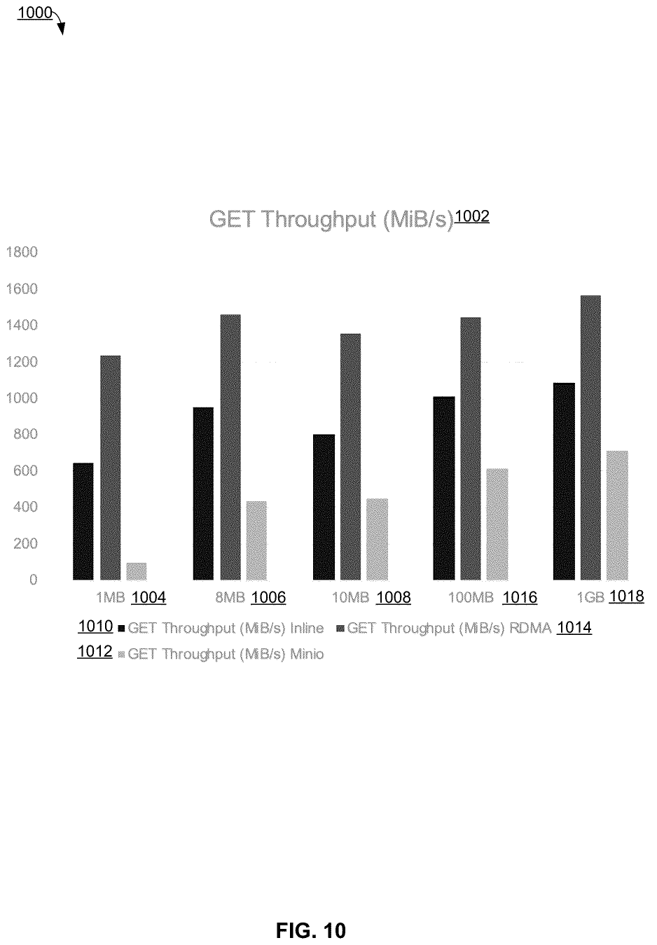

FIG. 10 illustrates another example chart 1000 of GET performance comparison, and that can facilitate object storage RDMA, in accordance with an embodiment of this disclosure. In some examples, part(s) of chart 1000 can be implemented by part(s) of system architecture 100 of FIG. 1 to facilitate object storage RDMA.

Chart 1000 comprises GET throughput (MiB/second (s)) 1002, 1 megabyte (MB) 1004, 8 MB 1006, 10 MB 1008, GET throughput (MiB/s) inline 1010, GET throughput (MiB/s) inline RDMA 1012, GET throughput (MiB/s) inline Minio 1014, 100 MB 1016, and 1 gigabyte (GB) 1018.

Chart 1000 illustrates latency associated with GET data transfers of different sizes (1 MB, 8 MB, 10 MB, 100 MB, and 1 GB) according to different approaches (inline, RDMA, minio). It can be seen that GET throughput (MiB/s) RDMA 1012 (according to the present techniques) offers the highest throughput at each data size.

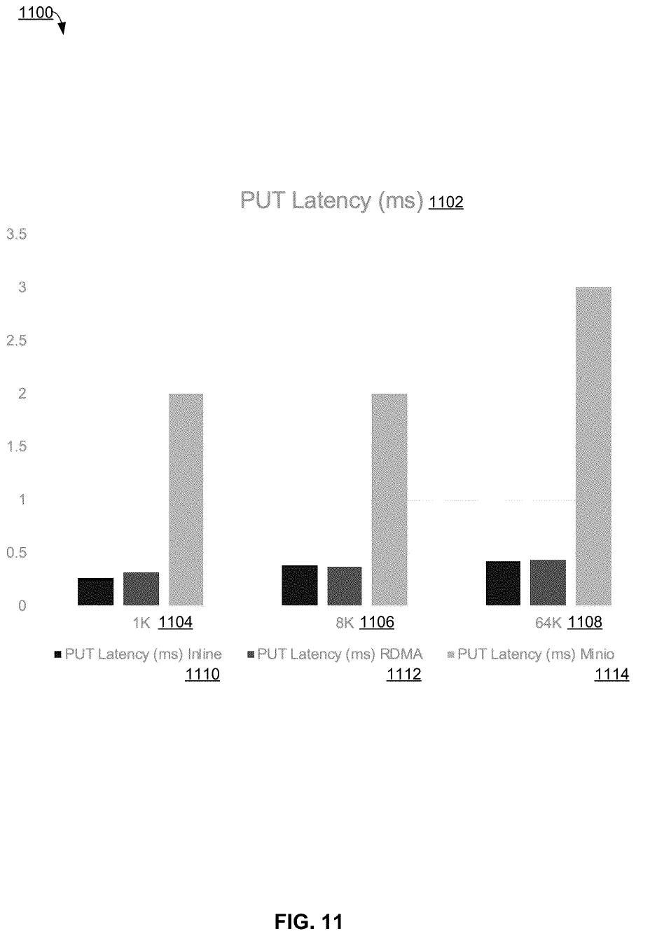

FIG. 11 illustrates an example chart of 1100 PUT performance comparison, and that can facilitate object storage RDMA, in accordance with an embodiment of this disclosure. In some examples, part(s) of chart 1100 can be implemented by part(s) of system architecture 100 of FIG. 1 to facilitate object storage RDMA.

Chart 1100 comprises latency (milliseconds (ms)) 1102, 1 kilobyte (KB) 1104, 8 KB 1106, 64 KB 1108, PUT latency (ms) inline 1110, PUT latency (ms) RDMA 1112, and PUT latency (ms) Minio 1114.

Chart 1100 illustrates latency associated with PUT data transfers of different sizes (1 KB, 8 KB, 64 KB) according to different approaches (inline, RDMA, minio). It can be seen that PUT latency (ms) RDMA 1112 (according to the present techniques) offers approximately the lowest latency at each data size.

In the examples of charts 1100 and 1200, the PUT operations can be effectuated using 8 MB chunks (where >8 MB is a multipart upload). The test can be input/output (I/O) bound at the server. Mini can utilize four parallel operations for multipart upload, while object storage RPC can be sequential.

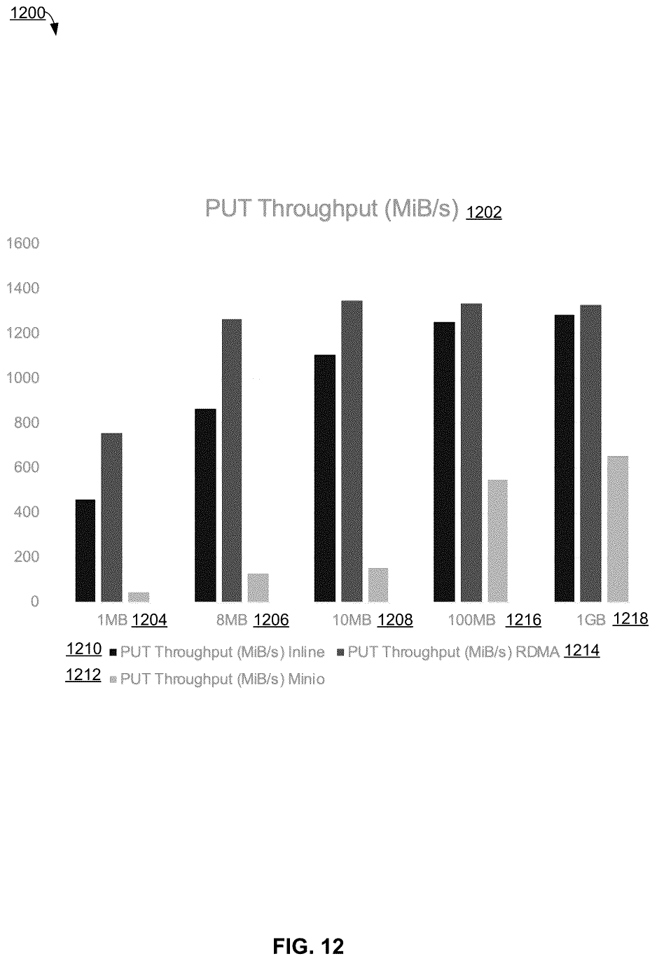

FIG. 12 illustrates another example chart 1200 of PUT performance comparison, and that can facilitate object storage RDMA, in accordance with an embodiment of this disclosure. In some examples, part(s) of chart 1200 can be implemented by part(s) of system architecture 100 of FIG. 1 to facilitate object storage RDMA.

Chart 1200 comprises GET throughput (MiB/second (s)) 1202, 1 megabyte (MB) 1204, 8 MB 1206, 10 MB 1208, PUT throughput (MiB/s) inline 1210, PUT throughput (MiB/s) inline RDMA 1212, PUT throughput (MiB/s) inline Minio 1214, 100 MB 1216, and 1 gigabyte (GB) 1218.

Chart 1200 illustrates latency associated with PUT data transfers of different sizes (1 MB, 8 MB, 10 MB, 100 MB, and 1 GB) according to different approaches (inline, RDMA, minio). It can be seen that PUT throughput (MiB/s) RDMA 1210 (according to the present techniques) offers the highest throughput at each data size.

Multiple part uploads with RDMA data transfers can be implemented as follows. An object storage protocol specification according to the present techniques can include multiple part uploads. With multiple part uploads, large objects can be transferred in parts from the client to the server. The parts can be finalized with a completion message, or aborted. Multiple part uploads can allow for incremental transfer of data, even as the data itself is being generated. The throughput of a multiple part upload can be increased by sending parts in parallel. In some examples, doing so can generate heavy CPU load on a client system and result in numerous data copies.

An object storage RPC according to the present techniques can provide operations to Create, Abort, and Complete a multipart upload. Within a multipart upload, the Upload Part operation ca be utilized to transfer portions of an object to a server. With direct transfer mode, the object storage RPC server can utilize RDMA to read data directly from object storage RPC memory (CPU, GPU, or otherwise) and store the part until the entire multipart upload is completed. The object storage RPC server can store the part in temporary storage with reduced redundancy, in some examples. Upon completion, the server can concatenate the parts and commit the entire object to stable storage.

Utilizing RDMA can allow the server to read client memory locations directly, as signaled by the client. This can be used for Gen AI checkpointing, where GPU memory can be written to the storage server. Using an object storage RPC, the client can create a multipart upload and then signal the server each time checkpointing completes to rapidly, and directly, transfer the data out of GPU memory without requiring a CPU bounce buffer or additional host processing. The same RDMA connections can be utilized for the offsets into a memory location that is being transformed during client-side processing—thus reducing any overhead related to connection setup or teardown.

Upload throughput can be scaled by creating an RDMA connection per RPC slot to the server. This can allow for multiple, parallel RDMA reads to be performed without data synchronization—until all parts have been uploaded.

The present techniques can facilitate an RDMA data transfer mechanism to perform object storage multipart upload semantics with very low overhead and directly from GPU or CPU memory. The present techniques can facilitate an ability to perform parallel RDMA data transfers without data synchronization, until signaled by the client that all parts have been uploaded.

The present techniques can be implemented to facilitate exactly once semantics for object storage RPC. Object storage can implement representational state transfer (REST) for exactly once semantics. In some examples, the implementation can differ based on the sever implementor. This can lead to unexpected behavior as non-idempotent operations can be replayed by the server. An example is the POST operation to delete an object (e.g., DeleteObject.) If a DeleteObject operation is replayed by the server, it can result in either a HTTP 200 (OK) response or a HTTP 404 (not-found) response for the object. With exactly once semantics, each operation can be performed exactly once and not repeated, unless allowed by the implementation for idempotent operations.

Object storage RPC can provide exactly once semantics through the creation of a server side object storage operation reply cache. The object storage reply cache can be created when an object storage RPC client sends an OBJECT_STORAGE_OP_CREATE_ENDPOINT_SESSION operation to the object storage RPC server. The operation can negotiate with the server regarding the size of the cache, the number of outstanding parallel operations, the largest response to cache, and the maximum number of operations which can be specified in an OBJECT_STORAGE_PROC_MESSAGE. The result can be a set number of RPC slots to be used for client connections and parallel operations, with available resources to cache responses on a per-slot basis. The response to a successful OBJECT_STORAGE_OP_CREATE_ENDPOINT_SESSION can be a unique session id.

Object storage RPC clients can utilize the session id and an OBJECT_STORAGE_OP_SEQUENCE operation to direct operations to specific slots in the object storage reply cache. The OBJECT_STORAGE_OP_SEQUENCE can comprise a sequence ID, which can be monotonically incremented with each new request. If the server sees an out of sequence operation, it can send an error to the client and not perform the operation. If the server sees a duplicate sequence ID directed at a specific slot, it can send a cached response, if one was saved, and not replay the operation. The use of sequenced operations can ensure that the last operations performed for a specific slot, by a specific client, are not repeated. This can be particularly useful for cases where network bisection occurs, and an object storage RPC client continues to retransmit a request over many minutes or hours.

The object storage RPC server can choose to store the reply cache, or portions of it, on local disk or a backing store in order to reduce the amount of server memory required for reply caching. Doing so can maximize (or efficiently utilize) the object storage RPC server memory for actual data and request handling.

An object storage cached response can include a marshaled object storage procedure message response. The cached response can be freed and replaced when the next valid sequence ID is processed by the server.

The use of slots can allow for a set number of outstanding parallel procedures to be sent by the client. One example use case can be an UploadPart operation, which can be sent in parallel with other parts without the need for sequencing. This ability to send parallel operations, and perform those operations exactly once, can allow an object storage RPC to scale throughput when uploading large files.

The present techniques can facilitate a built-in protocol mechanism to define a stateful reply cache which allows for parallel object storage operations which are performed exactly once. This can address an issue with prior object storage protocols, which can lead to client incompatibility based on server implementation.

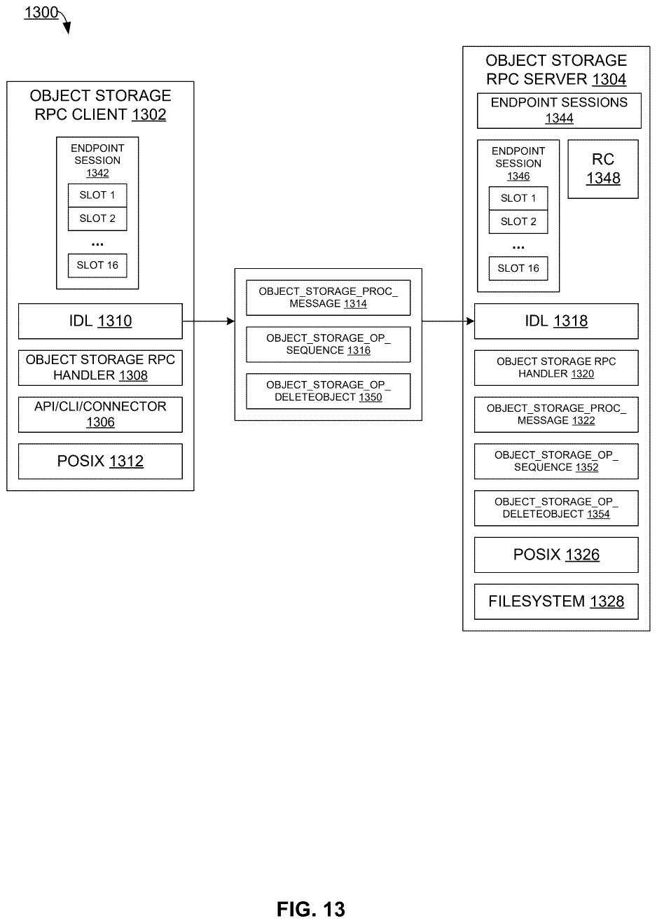

FIG. 13 illustrates an example 1300 of an object storage RPC with endpoint sessions, and that can facilitate object storage RDMA, in accordance with an embodiment of this disclosure. In some examples, part(s) of example 1300 can be implemented by part(s) of system architecture 100 of FIG. 1 to facilitate object storage RDMA.

Example 1300 comprises object storage RPC client 1302, object storage RPC server 1304, API/command line interface (CLI)/connector 1306, object storage RPC handler 1308, IDL 1310, Portable Operating System Interface (POSIX) 1312, OBJECT_STORAGE_PROC_MESSAGE 1314, IDL 1318, object storage RPC handler 1320, OBJECT_STORAGE_PROC_MESSAGE 1322, POSIX 1326, filesystem 1328. These parts of example 1300 can be similar to object storage RPC client 702, object storage RPC server 704, API/command line interface (CLI)/connector 706, object storage RPC handler 708, IDL 710, Portable Operating System Interface (POSIX) 712, IDL 718, object storage RPC handler 720, OBJECT_STORAGE_PROC_MESSAGE 722, POSIX 726, filesystem 728, and local FS 730, respectively.

Example 1300 also comprises OBJECT_STORAGE_OP_SEQUENCE 1316, endpoint session 1342, endpoint sessions 1344, endpoint session 1346, RC 1348, OBJECT_STORAGE_OP_DELETEOBJECT 1350, OBJECT_STORAGE_OP_SEQUENCE 1352, and OBJECT_STORAGE_OP_DELETEOBJECT 1354.

The present techniques can be implemented to facilitate slot-based RDMA connections for an object storage RPC.

RDMA can provide low latency and high throughput data transfer. For a request/response protocol like object storage, having to incur frequent creation and teardown of RDMA connections can present significant overhead that can overwhelm the advantages to data transfer performance. How and when to set up these connections can be important to support direct data transfer.

An object storage RPC can use an RPC connection between client and server. The RPC connection can be reused when sending many object storage procedure messages. To support parallel operations, object storage session endpoints can be used to create independent slots to cache and sequence object storage operations. An object storage RPC can also introduce stateful RDMA connection management through the OBJECT_STORAGE_OP_RDMA_CONNECT and OBJECT_STORAGE_OP_RDMA_DISCONNECT operations. When an endpoint session is created, the client can track state related to each RPC slot it has configured with the server. This state can include the RPC connection, the next or current sequence ID, and outstanding operations. Additionally, the client can create an object storage RDMA side channel connection from the object storage RPC server back to the client. The client can create one object storage RDMA connection per slot and store the RDMA connection ID with the slot state.

By creating an RDMA connection per slot and organizing slots to enable parallel RPC messages and RDMA data transfers, the client can achieve high throughput data transfers. Additionally, the client can disconnect and create new RDMA connections without disrupting other existing connections being utilized for data transfer with the object storage RPC server.

One use case for object storage RDMA can be for general object storage client acceleration. In this model, the client can allocate a “chunk size” memory region, per slot, to utilize for RDMA based data transfers. An object storage protocol can lend itself for multiple part operations that can utilize the same memory region when transferring data from a local filesystem.

The server can choose not to persist RDMA connections. The server can also choose to close connections that have not been recently used, in order to free up resources. If a client utilizes an RDMA connection ID that no longer exists, the server can respond with an OBJECT_STORAGE_ERR_RDMA_INVAL error. Object storage RPC clients can be encouraged to issue OBJECT_STORAGE_OP_RDMA_DISCONNECT messages for unused connections.

The present techniques can be implemented to facilitate an RDMA connection management scheme to enable long lived connections for object storage data transfer. RDMA connections can be organized and grouped in a stateful manner on a per RPC slot and connection basis. Parallelism in the client can be supported through use of tight coupling between RPC slots and RDMA connections.

GPU direct data transfer with object storage RPC can be implemented as follows. GPUs can provide significant value in accelerating Gen-AI training workloads. To get data object storage data into a GPU, it can first be placed into CPU host memory by either reading a local file or getting an object from an object server. The CPU memory can then be copied into GPU memory. This technique can be referred to as using a “CPU bounce buffer.” It can be inefficient and can result in stalls when a GPU needs to be loaded with new data, or when data needs to be written out from GPU memory during checkpointing.

An object storage RPC can remove a need for a CPU bounce buffer by transferring data directly into GPU memory or from GPU memory to the object storage RPC server. The object storage RPC client can register a GPU memory region with RDMA. The object storage RPC client can then create an RDMA connection using the OBJECT_STORAGE_OP_RDMA_CONNECT operation, specifying the client-side address of the GPU buffer.

To load data into GPU memory, the object storage RPC client can issue a series of GetObject requests for a range of object data using a specific chunk size (e.g., 8 mebibytes (MiB)). The request can include the bucket and key referencing the object, the length and offset of the GET request, and the offset into the client side buffer. The client can issue as many GetObject requests as needed to load the GPU memory region that has been registered. The object storage RPC server can use the RDMA connection to write the object data, one chunk at a time, to the GPU memory on the client. This RDMA transfer can be accomplished without a need for a CPU bounce buffer or establishing a new connection or queue pair with each transfer.

To checkpoint data from GPU memory, the object storage RPC client can send a PutObject, for data less than or equal to the chunk size, and a multiple part upload for data larger than the chunk size. The request can include the bucket and key (and/or upload ID) referencing the object, and the length and offset within the GPU memory buffer to read. The object storage RPC server can use the RDMA connection to read the data directly from the GPU memory. This RDMA transfer can be accomplished without the use of a CPU bounce buffer or establishing a new connection or queue pair with each transfer.

When the GPU memory is released, the object storage RPC client can issue an OBJECT_STORAGE_OP_RDMA_DISCONNECT operation to close the RDMA connection and free up server resources.

The present techniques can be implemented to facilitate direct transfer with an object storage object server and GPU memory, without a need for a CPU bounce buffer or data copies.

### Example Procss Flows

FIG. 14 illustrates an example process flow that can facilitate object storage RDMA, in accordance with an embodiment of this disclosure. In some examples, one or more embodiments of process flow 1400 can be implemented by system architecture 100 of FIG. 1, or computing environment 1700 of FIG. 17.

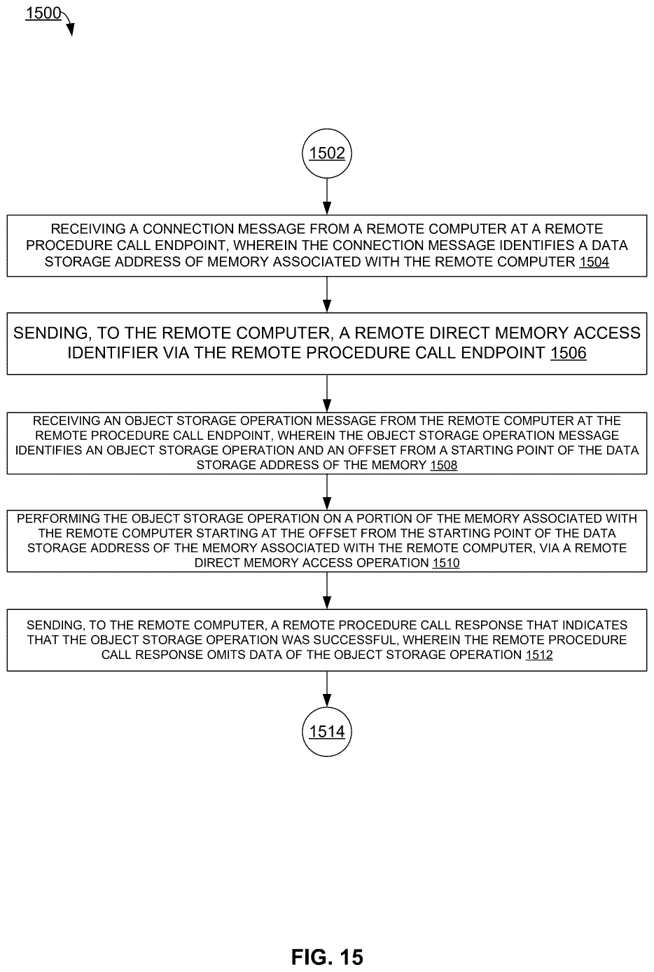

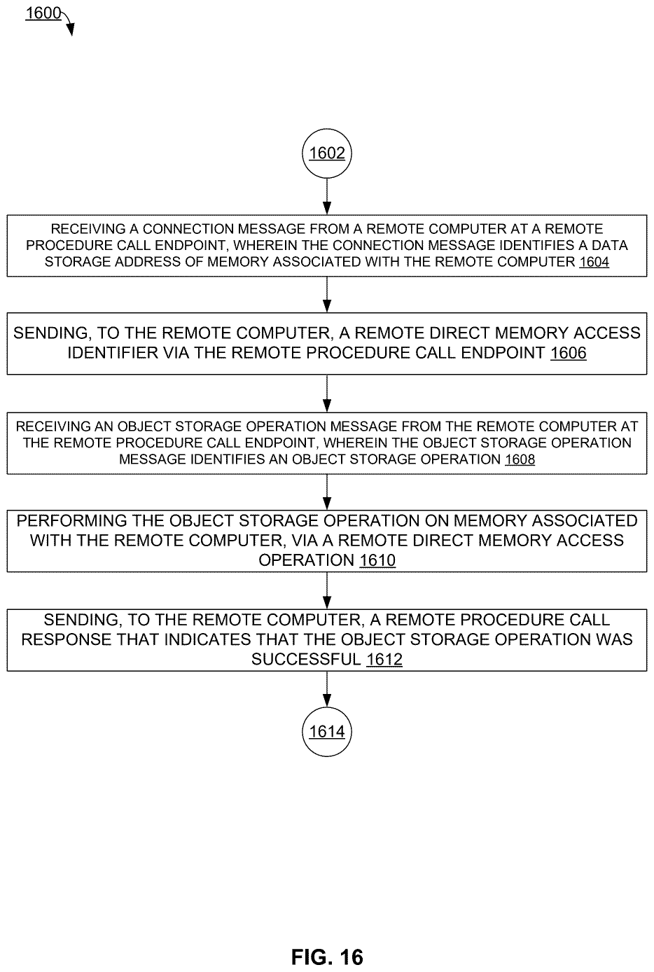

It can be appreciated that the operating procedures of process flow 1400 are example operating procedures, and that there can be embodiments that implement more or fewer operating procedures than are depicted, or that implement the depicted operating procedures in a different order than as depicted. In some examples, process flow 1400 can be implemented in conjunction with one or more embodiments of process flow process flow 1500 of FIG. 15, and/or process flow 1600 of FIG. 16.

Process flow 1400 begins with 1402, and moves to operation 1404.

Operation 1404 depicts exposing a remote procedure call endpoint that is accessible by a remote computer to request performing object storage operations with the system. Using the example of FIG. 1, the remote procedure call endpoint can be RPC endpoint 112, the system can be server 106 and the remote computer can be client computer 102.

After operation 1404, process flow 1400 moves to operation 1406.

Operation 1406 depicts receiving a connection message from the remote computer at the remote procedure call endpoint, wherein the connection message identifies a data storage address of memory associated with the remote computer. This connection message can be similar to that depicted in FIG. 4, and the data storage address of memory associated with the remote computer can be a location in memory space 110 of FIG. 1.

After operation 1406, process flow 1400 moves to operation 1408.

Operation 1408 depicts based on receiving the connection message, sending, to the remote computer, a remote direct memory access identifier via the remote procedure call endpoint.

After operation 1408, process flow 1400 moves to operation 1410. This remote direct memory access identifier can be similar to that depicted in FIG. 5 Operation 1410 depicts after sending the remote direct memory access identifier to the remote computer, receiving an object storage operation message from the remote computer at the remote procedure call endpoint, wherein the object storage operation message identifies an object storage operation and an offset from a starting point of the data storage address of the memory. The object storage operation message can be similar to the GetObject of FIG. 6, a PutObject, or a CreateMultipartUpload.

Inn some examples, the offset is a first offset, and the object storage operation comprises a GET operation, and the object storage operation message identifies a bucket, a key, a second offset into the bucket, and a length of data to read. In some examples, the object storage operation comprises a GET operation, and the remote procedure call response identifies an amount of data written to the remote computer, via the remote direct memory access operation, as part of servicing the object storage operation. That is, in a case of a GetObject, an object storage RPC client can specify the bucket and key representing the object, offset and length information for the operation, an RDMA connection ID to use, and an offset into the client buffer. The object storage RPC server can process the GetObject RPC message and validates the request.

In some examples, the object storage operation comprises a PUT operation, and the object storage operation message identifies a length of data to write from the remote computer to storage of the system. In some examples, an object to be transferred as part of the PUT operation is loaded into the memory associated with the remote computer at the offset from the starting point of the data storage address of the memory associated with the remote computer. That is, in a case of a PutObject, the object storage RPC client can load the data into the registered memory region and issue a PutObject object storage RPC request. This request can comprise the bucket and key representing the object (either a new object, or one to be overwritten), the RDMA connection id, and an offset and length into the local memory region.

In some examples, the object storage operation comprises a multipart upload operation, and performing the object storage operation comprises iteratively performing, performing the remote direct memory access operation, and receiving a checkpointing signal from the remote computer that a respective part of parts of the mulitpart upload operation has been uploaded. That is, using object storage RPC, the client can create a multipart upload and then signal the server each time checkpointing completes to rapidly, and directly, transfer the data out of GPU memory without requiring a CPU bounce buffer or additional host processing. The same RDMA connections can be utilized for the offsets into a memory location that is being transformed during client-side processing—thus reducing any overhead related to connection setup or teardown.

In some examples, the object storage operation comprises a multipart upload operation, and performing the object storage operation comprises performing parallel remote direct memory access operations that comprise the remote direct memory access operation. That is, upload throughput can be scaled by creating an RDMA connection per RPC slot to the server. This can allow for multiple, parallel RDMA reads to be performed without a need for data synchronization—until all parts have been uploaded.

After operation 1410, process flow 1400 moves to operation 1412.

Operation 1412 depicts performing the object storage operation on a portion of the memory associated with the remote computer starting at the offset from the starting point of the data storage address of the memory associated with the remote computer, via a remote direct memory access operation. This can be performed in a similar manner as depicted in FIGS. 7-8 (for GetObject).

After operation 1412, process flow 1400 moves to operation 1414.

Operation 1414 depicts based on determining, from a remote direct memory access event queue of the system, that the object storage operation has completed, sending, to the remote computer, a remote procedure call response that indicates that the object storage operation was successful, wherein the remote procedure call response omits data of the object storage operation. Using the example of FIG. 1, the remote direct memory access event queue can be located on server 106, and RDMA application 114 can identify from it that a particular object storage operation (e.g., a GET or a PUT) has completed. The server can send an RPC response to the client that the operation succeeded, where this RPC response does not contain data of the operation (e.g., does not send data of an object to the client as part of a GET operation).

After operation 1412, process flow 1400 moves to 1416, where process flow 1400 ends.

FIG. 15 illustrates another example process flow that can facilitate object storage RDMA, in accordance with an embodiment of this disclosure. In some examples, one or more embodiments of process flow 1500 can be implemented by system architecture 100 of FIG. 1, or computing environment 1700 of FIG. 17.

It can be appreciated that the operating procedures of process flow 1500 are example operating procedures, and that there can be embodiments that implement more or fewer operating procedures than are depicted, or that implement the depicted operating procedures in a different order than as depicted. In some examples, process flow 1500 can be implemented in conjunction with one or more embodiments of process flow process flow 1400 of FIG. 14, and/or process flow 1600 of FIG. 16.

Process flow 1500 begins with 1502, and moves to operation 1504.

Operation 1504 depicts receiving a connection message from a remote computer at a remote procedure call endpoint, wherein the connection message identifies a data storage address of memory associated with the remote computer. In some examples, operation 1504 can be implemented in a similar manner as operations 1404-1406 of FIG. 14.

In some examples, the connection message identifies a key associated with the remote computer.

In some examples, the connection message identifies a remote direct memory access descriptor associated with the remote computer.

After operation 1504, process flow 1500 moves to operation 1506.

Operation 1506 depicts sending, to the remote computer, a remote direct memory access identifier via the remote procedure call endpoint. In some examples, operation 1506 can be implemented in a similar manner as operation 1408 of FIG. 14.

After operation 1506, process flow 1500 moves to operation 1508.

Operation 1508 depicts receiving an object storage operation message from the remote computer at the remote procedure call endpoint, wherein the object storage operation message identifies an object storage operation and an offset from a starting point of the data storage address of the memory. In some examples, operation 1508 can be implemented in a similar manner as operation 1410 of FIG. 14.

In some examples, the object storage operation is a first object storage operation, and a second object storage operation comprises transferring data inline as part of a remote procedure call message payload. That is, smaller transfers can be performed inline in an object storage RPC message as opposed to via RDMA.

In some examples, the offset is a first offset, and the object storage operation message identifies a bucket, and a key. That is, an RPC client can specify the bucket and key representing the object.

In some examples, the object storage operation message identifies the remote direct memory access identifier. That is, an RPC client can identify an RDMA connection ID in its messages.

After operation 1508, process flow 1500 moves to operation 1510.

Operation 1510 depicts performing the object storage operation on a portion of the memory associated with the remote computer starting at the offset from the starting point of the data storage address of the memory associated with the remote computer, via a remote direct memory access operation. In some examples, operation 1510 can be implemented in a similar manner as operation 1412 of FIG. 14.

In some examples, a first data channel comprises the remote procedure call endpoint, the remote direct memory access operation is performed via a second data channel, and the second data channel comprises a side channel relative to the first data channel. That is, an RDMA side-channel can be utilized to directly write data into the client memory at a specified offset.

After operation 1510, process flow 1500 moves to operation 1512.

Operation 1512 depicts sending, to the remote computer, a remote procedure call response that indicates that the object storage operation was successful, wherein the remote procedure call response omits data of the object storage operation. In some examples, operation 1512 can be implemented in a similar manner as operation 1414 of FIG. 14.

After operation 1512, process flow 1500 moves to 1514, where process flow 1500 ends.

FIG. 16 illustrates another example process flow that can facilitate object storage RDMA, in accordance with an embodiment of this disclosure. In some examples, one or more embodiments of process flow 1600 can be implemented by system architecture 100 of FIG. 1, or computing environment 1700 of FIG. 17.

It can be appreciated that the operating procedures of process flow 1600 are example operating procedures, and that there can be embodiments that implement more or fewer operating procedures than are depicted, or that implement the depicted operating procedures in a different order than as depicted. In some examples, process flow 1600 can be implemented in conjunction with one or more embodiments of process flow process flow 1400 of FIG. 14, and/or process flow 1500 of FIG. 15.

Process flow 1600 begins with 1602, and moves to operation 1604.

Operation 1604 depicts receiving a connection message from a remote computer at a remote procedure call endpoint, wherein the connection message identifies a data storage address of memory associated with the remote computer. In some examples, operation 1604 can be implemented in a similar manner as operations 1404-1406 of FIG. 14.

In some examples, the memory associated with the remote computer comprises memory of a central processing unit of the remote computer. In some examples, the memory associated with the remote computer comprises memory of a graphics processing unit of the remote computer. In some examples, the memory associated with the remote computer comprises addressable virtual memory of a device that is separate from the remote computer, and wherein the addressable virtual memory is addressable by the remote computer.

After operation 1604, process flow 1600 moves to operation 1606.

Operation 1606 depicts sending, to the remote computer, a remote direct memory access identifier via the remote procedure call endpoint. In some examples, operation 1606 can be implemented in a similar manner as operation 1408 of FIG. 14.

After operation 1606, process flow 1600 moves to operation 1608.

Operation 1608 depicts receiving an object storage operation message from the remote computer at the remote procedure call endpoint, wherein the object storage operation message identifies an object storage operation. In some examples, operation 1608 can be implemented in a similar manner as operation 1410 of FIG. 14.

After operation 1608, process flow 1600 moves to operation 1610.

Operation 1610 depicts performing the object storage operation on memory associated with the remote computer, via a remote direct memory access operation. In some examples, operation 1610 can be implemented in a similar manner as operation 1412 of FIG. 14.

In some examples, the remote procedure call endpoint facilitates a stateful connection with the remote computer. In some examples, the remote direct memory access operation is performed via a stateless connection.

After operation 1610, process flow 1600 moves to operation 1612.

Operation 1612 depicts sending, to the remote computer, a remote procedure call response that indicates that the object storage operation was successful. In some examples, operation 1612 can be implemented in a similar manner as operation 1414 of FIG. 14.

After operation 1612, process flow 1600 moves to 1614, where process flow 1600 ends.

### Example Operating Environment

In order to provide additional context for various embodiments described herein, FIG. 17 and the following discussion are intended to provide a brief, general description of a suitable computing environment 1700 in which the various embodiments of the embodiment described herein can be implemented.

For example, parts of computing environment 1700 can be used to implement one or more embodiments of client computer 102 and/or server 106 of FIG. 1.

In some examples, computing environment 1700 can implement one or more embodiments of the process flows of FIGS. 14-16 to facilitate object storage RDMA.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 17, the example environment 1700 for implementing various embodiments described herein includes a computer 1702, the computer 1702 including a processing unit 1704, a system memory 1706 and a system bus 1708. The system bus 1708 couples system components including, but not limited to, the system memory 1706 to the processing unit 1704. The processing unit 1704 can be any of various commercially available processors. Dual microprocessors and other multi-processor architectures can also be employed as the processing unit 1704.

The system bus 1708 can be any of several types of bus structure that can further interconnect to a memory bus (with or without a memory controller), a peripheral bus, and a local bus using any of a variety of commercially available bus architectures. The system memory 1706 includes ROM 1710 and RAM 1712. A basic input/output system (BIOS) can be stored in a nonvolatile storage such as ROM, erasable programmable read only memory (EPROM), EEPROM, which BIOS contains the basic routines that help to transfer information between elements within the computer 1702, such as during startup. The RAM 1712 can also include a high-speed RAM such as static RAM for caching data.

The computer 1702 further includes an internal hard disk drive (HDD) 1714 (e.g., EIDE, SATA), one or more external storage devices 1716 (e.g., a magnetic floppy disk drive (FDD) 1716, a memory stick or flash drive reader, a memory card reader, etc.) and an optical disk drive 1720 (e.g., which can read or write from a CD-ROM disc, a DVD, a BD, etc.). While the internal HDD 1714 is illustrated as located within the computer 1702, the internal HDD 1714 can also be configured for external use in a suitable chassis (not shown). Additionally, while not shown in environment 1700, a solid state drive (SSD) could be used in addition to, or in place of, an HDD 1714. The HDD 1714, external storage device(s) 1716 and optical disk drive 1720 can be connected to the system bus 1708 by an HDD interface 1724, an external storage interface 1726 and an optical drive interface 1728, respectively. The interface 1724 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1702, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1712, including an operating system 1730, one or more application programs 1732, other program modules 1734 and program data 1736. All or portions of the operating system, applications, modules, and/or data can also be cached in the RAM 1712. The systems and methods described herein can be implemented utilizing various commercially available operating systems or combinations of operating systems.

Computer 1702 can optionally comprise emulation technologies. For example, a hypervisor (not shown) or other intermediary can emulate a hardware environment for operating system 1730, and the emulated hardware can optionally be different from the hardware illustrated in FIG. 17. In such an embodiment, operating system 1730 can comprise one virtual machine (VM) of multiple VMs hosted at computer 1702. Furthermore, operating system 1730 can provide runtime environments, such as the Java runtime environment or the. NET framework, for applications 1732. Runtime environments are consistent execution environments that allow applications 1732 to run on any operating system that includes the runtime environment. Similarly, operating system 1730 can support containers, and applications 1732 can be in the form of containers, which are lightweight, standalone, executable packages of software that include, e.g., code, runtime, system tools, system libraries and settings for an application.

Further, computer 1702 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1702, e.g., applied at the application execution level or at the operating system (OS) kernel level, thereby enabling security at any level of code execution.

A user can enter commands and information into the computer 1702 through one or more wired/wireless input devices, e.g., a keyboard 1738, a touch screen 1740, and a pointing device, such as a mouse 1742. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1704 through an input device interface 1744 that can be coupled to the system bus 1708, but can be connected by other interfaces, such as a parallel port, an IEEE 1394 serial port, a game port, a USB port, an IR interface, a BLUETOOTH® interface, etc.

A monitor 1746 or other type of display device can be also connected to the system bus 1708 via an interface, such as a video adapter 1748. In addition to the monitor 1746, a computer typically includes other peripheral output devices (not shown), such as speakers, printers, etc.

The computer 1702 can operate in a networked environment using logical connections via wired and/or wireless communications to one or more remote computers, such as a remote computer(s) 1750. The remote computer(s) 1750 can be a workstation, a server computer, a router, a personal computer, portable computer, microprocessor-based entertainment appliance, a peer device or other common network node, and typically includes many or all of the elements described relative to the computer 1702, although, for purposes of brevity, only a memory/storage device 1752 is illustrated. The logical connections depicted include wired/wireless connectivity to a local area network (LAN) 1754 and/or larger networks, e.g., a wide area network (WAN) 1756. Such LAN and WAN networking environments are commonplace in offices and companies, and facilitate enterprise-wide computer networks, such as intranets, all of which can connect to a global communications network, e.g., the Internet.

When used in a LAN networking environment, the computer 1702 can be connected to the local network 1754 through a wired and/or wireless communication network interface or adapter 1758. The adapter 1758 can facilitate wired or wireless communication to the LAN 1754, which can also include a wireless access point (AP) disposed thereon for communicating with the adapter 1758 in a wireless mode.

When used in a WAN networking environment, the computer 1702 can include a modem 1760 or can be connected to a communications server on the WAN 1756 via other means for establishing communications over the WAN 1756, such as by way of the Internet. The modem 1760, which can be internal or external and a wired or wireless device, can be connected to the system bus 1708 via the input device interface 1744. In a networked environment, program modules depicted relative to the computer 1702 or portions thereof, can be stored in the remote memory/storage device 1752. It will be appreciated that the network connections shown are examples, and other means of establishing a communications link between the computers can be used.

When used in either a LAN or WAN networking environment, the computer 1702 can access cloud storage systems or other network-based storage systems in addition to, or in place of, external storage devices 1716 as described above. Generally, a connection between the computer 1702 and a cloud storage system can be established over a LAN 1754 or WAN 1756 e.g., by the adapter 1758 or modem 1760, respectively. Upon connecting the computer 1702 to an associated cloud storage system, the external storage interface 1726 can, with the aid of the adapter 1758 and/or modem 1760, manage storage provided by the cloud storage system as it would other types of external storage. For instance, the external storage interface 1716 can be configured to provide access to cloud storage sources as if those sources were physically connected to the computer 1702.

The computer 1702 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations.

That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
exposing a remote procedure call endpoint that is accessible by a remote computer to request performing object storage operations with the system;
receiving a connection message from the remote computer at the remote procedure call endpoint, wherein the connection message identifies a data storage address of memory associated with the remote computer;
based on receiving the connection message, sending, to the remote computer, a remote direct memory access identifier via the remote procedure call endpoint;
after sending the remote direct memory access identifier to the remote computer, receiving an object storage operation message from the remote computer at the remote procedure call endpoint, wherein the object storage operation message identifies an object storage operation and an offset from a starting point of the data storage address of the memory;
performing the object storage operation on a portion of the memory associated with the remote computer starting at the offset from the starting point of the data storage address of the memory associated with the remote computer, via a remote direct memory access operation; and
based on determining, from a remote direct memory access event queue of the system, that the object storage operation has completed, sending, to the remote computer, a remote procedure call response that indicates that the object storage operation was successful, wherein the remote procedure call response omits data of the object storage operation.

2. The system of claim 1, wherein the offset is a first offset, and wherein the object storage operation comprises a GET operation, and wherein the object storage operation message identifies a bucket, a key, a second offset into the bucket, and a length of data to read.

3. The system of claim 1, wherein the object storage operation comprises a GET operation, and wherein the remote procedure call response identifies an amount of data written to the remote computer, via the remote direct memory access operation, as part of servicing the object storage operation.

4. The system of claim 1, wherein the object storage operation comprises a PUT operation, and wherein the object storage operation message identifies a length of data to write from the remote computer to storage of the system.

5. The system of claim 4, wherein an object to be transferred as part of the PUT operation is loaded into the memory associated with the remote computer at the offset from the starting point of the data storage address of the memory associated with the remote computer.

6. The system of claim 1, wherein the object storage operation comprises a multipart upload operation, and wherein the performing of the object storage operation comprises:
iteratively performing,
performing the remote direct memory access operation, and
receiving a checkpointing signal from the remote computer that a respective part of parts of the mulitpart upload operation has been uploaded.

7. The system of claim 1, wherein the object storage operation comprises a multipart upload operation, and wherein the performing of the object storage operation comprises:
performing parallel remote direct memory access operations that comprise the remote direct memory access operation.

8. A method, comprising:
receiving, by a system comprising at least one processor, a connection message from a remote computer at a remote procedure call endpoint, wherein the connection message identifies a data storage address of memory associated with the remote computer;
sending, by the system to the remote computer, a remote direct memory access identifier via the remote procedure call endpoint;
receiving, by the system, an object storage operation message from the remote computer at the remote procedure call endpoint, wherein the object storage operation message identifies an object storage operation and an offset from a starting point of the data storage address of the memory;
performing, by the system, the object storage operation on a portion of the memory associated with the remote computer starting at the offset from the starting point of the data storage address of the memory associated with the remote computer, via a remote direct memory access operation; and
sending, by the system to the remote computer, a remote procedure call response that indicates that the object storage operation was successful, wherein the remote procedure call response omits data of the object storage operation.

9. The method of claim 8, wherein the object storage operation is a first object storage operation, and wherein a second object storage operation comprises transferring data inline as part of a remote procedure call message payload.

10. The method of claim 8, wherein the offset is a first offset, and wherein the object storage operation message identifies a bucket, and a key.

11. The method of claim 8, wherein the object storage operation message identifies the remote direct memory access identifier.

12. The method of claim 8, wherein the connection message identifies a key associated with the remote computer.

13. The method of claim 8, wherein the connection message identifies a remote direct memory access descriptor associated with the remote computer.

14. The method of claim 8, wherein a first data channel comprises the remote procedure call endpoint, wherein the remote direct memory access operation is performed via a second data channel, and wherein the second data channel comprises a side channel relative to the first data channel.

15. A non-transitory computer-readable medium comprising instructions that, in response to execution, cause a system comprising at least one processor to perform operations, comprising:
receiving a connection message from a remote computer at a remote procedure call endpoint, wherein the connection message identifies a data storage address of memory associated with the remote computer;
sending, to the remote computer, a remote direct memory access identifier via the remote procedure call endpoint;
receiving an object storage operation message from the remote computer at the remote procedure call endpoint, wherein the object storage operation message identifies an object storage operation;
performing the object storage operation on memory associated with the remote computer, via a remote direct memory access operation; and
sending, to the remote computer, a remote procedure call response that indicates that the object storage operation was successful.

16. The non-transitory computer-readable medium of claim 15, wherein the remote procedure call endpoint facilitates a stateful connection with the remote computer.

17. The non-transitory computer-readable medium of claim 16, wherein the remote direct memory access operation is performed via a stateless connection.

18. The non-transitory computer-readable medium of claim 15, wherein the memory associated with the remote computer comprises memory of a central processing unit of the remote computer.

19. The non-transitory computer-readable medium of claim 15, wherein the memory associated with the remote computer comprises memory of a graphics processing unit of the remote computer.

20. The non-transitory computer-readable medium of claim 15, wherein the memory associated with the remote computer comprises addressable virtual memory of a device that is separate from the remote computer, and wherein the addressable virtual memory is addressable by the remote computer.
